(19) United States
(12) Patent Application Publication
(10) Pub. No.: US 2011/0272357 A1
(43) Pub. Date: Nov. 10, 2011

(54) APPARATUS AND METHOD FOR MATERIAL SEPARATION

(75) Inventors: Andrzej Gorak, Witten (DE); Peter Kreis, Dortmund (DE); Peter Van Beijeren Bergen en Henegouwen, Koeln (DE); Rene Faber, Goettingen (DE); Wolfgang Demmer, Goettingen (DE); Constantin Frerick, Koeln (DE)

(73) Assignee: SARTORIUS STEDIM BIOTECH GMBH, Goettingen (DE)

(21) Appl. No.: 13/144,352

(22) PCT Filed: Dec. 2, 2009
(86) PCT No.: PCT/EP09/08575

§ 371 Date: Jul. 13, 2011

(30) Foreign Application Priority Data
Jan. 21, 2009 (DE) 10 2009 005 479.0

(51) Int. Cl. B01D 15/08

(52) U.S. Cl. 210/656; 210/198.2

(57) ABSTRACT

An apparatus for separating or isolating substances in or from a mixture has at least one diffusion-based chromatography matrix and at least one convection-based chromatography matrix.

### BACKGROUND OF THE INVENTION

1. Field of the Invention

The present invention relates to an apparatus for separating or isolating substances in or from a mixture, wherein the apparatus comprises at least one diffusion-based chromatography matrix and at least one convection-based chromatography matrix. Furthermore, the present invention relates both to the use of this apparatus and to a method for separating and/or isolating substances in or from a mixture.

2. Description of the Related Art

Physical separation methods in which the material separation occurs through distribution between a stationary phase and a mobile phase are known by the term chromatography. Examples of such chromatography methods are gel-permeation chromatography (GPC), adsorption chromatography, affinity chromatography, ion-exchange chromatography and hydrophobic interaction chromatography.

The performance of such chromatographic separation systems is usually assessed by the productivity, the dynamic capacity, and the position of the breakthrough curve in the chromatogram for the particular chromatography system. In this context, productivity refers to the amount of product recovered from the apparatus per unit time and per unit volume of the adsorbent used in the particular chromatography system. The dynamic binding capacity is defined as the amount of substance and thus the volume which has passed through the adsorber up to the time at which the concentration of the substance in the outflow of the adsorber is a certain fraction of the concentration of the substance in the inflow. For practical reasons, 5 or 10% of the inflow concentration is specified.

To record the complete breakthrough curve, the fluid containing the substance is conducted through the adsorber until the capacity thereof is exhausted, i.e. it is completely laden with substance. The concentration of the substance in the outflow is then just as high as that in the inflow. This results in a sigmoidal curve. By integrating the area under the curve from the starting point up to the point of the maximum concentration, the amount of substance unbound can be determined; by integrating the area above the curve, the amount of substance bound can be determined. The ratio of the two areas permits conclusions about the quality of the adsorber system.

In this connection, one example of an effective measure for improving the productivity is the raising of the linear flow rate. However, this has the general disadvantage that the breakthrough of the target substance occurs much earlier and thus the yield regularly decreases significantly, particularly when the amount of product to be purified remains constant in each loading cycle. Gel-permeation chromatography with porous beads in this regard additionally has the disadvantage of the diffusion limitation of mass transfer and, as a result, a sharp decline in the dynamic binding capacity with increasing linear flow rate. At the same time, this results in a flatter breakthrough curve. This is particularly pronounced when the adsorption mechanism is not based on long-range electrostatic interactions, as in the case of ion exchangers, but is based, in what are called affinity chromatography methods, on the combination of forces which are effective only at short distances (on the molecular scale), such as coulombic, dipole and/or hydrophobic interactions. The target molecule to be bound and the specific ligand have to come into close spatial proximity and correct orientation. An increase in the linear flow rate results here in an extremely significant lowering of the dynamic binding capacity (cf. Hahn et al., J. Chromatogr. A, 2005, 1093, pages 98-110).

In gel-permeation chromatography, the separation columns are usually filled with beads of a porous, highly crosslinked material. Conducted through this material is a fluid which comprises substances of differing molecular size. Substances of smaller molecular size, i.e. having a smaller hydrodynamic volume, diffuse into the solvent interface or into the pores of the gel and remain there until they diffuse back out of the solvent interface or the pores. In the case of larger molecules, these diffusion processes occur much more slowly, resulting in a fractionation of the individual substances according to their molecular size.

Gel-permeation chromatography is therefore a separation method which is commonly used both in chemical and in pharmaceutical development and production, more particularly for the isolation of biomolecules from complex mixtures which, for example, arise during the production of proteins in microorganisms or during the isolation of individual constituents from biological fluids, such as blood. Gel chromatography columns have a high dynamic capacity, but can be run only with relatively low flow rates.

In (membrane) adsorption chromatography, in contrast to gel-permeation chromatography, there is binding of components of a fluid, for example individual molecules, associates or particles, to the surface of a solid in contact with the fluid.

A solid capable of adsorption is called an “adsorbent”, and the component to be adsorbed is called an “adsorbate”. Adsorption can be used industrially for adsorptive material separation, which is carried out in apparatuses called “adsorbers”. The adsorbate is referred to as a “target substance” when its recovery from the fluid is intended, and as a “contaminant” when it is to be removed from said fluid. In the first case, the adsorption has to be reversible, and the adsorption is followed, as a second step of the method, under modified conditions (composition and/or temperature) of the fluid, by the elution of the adsorbate. A target substance can be present as a single component in the fluid, and so the material separation is merely an enrichment, or there are multiple components which are to be separated. In this case, at least one of the steps of the method has to be selective, i.e. has to be achieved to different extents for the components to be separated.

The mass of the adsorbate bound in equilibrium, based on the mass unit of the adsorbent, is called “static binding capacity”. The dependence thereof on the concentration of the adsorbate in the fluid is described by the adsorption isotherm. An important factor for the capacity of an adsorber is its specific surface area, which is why adsorbents preferably have a high porosity. A distinction is made between outer specific surface area, i.e. the geometric surface area-mass ratio, and the inner specific surface area, i.e. the pore surface area-mass ratio. A prerequisite for the binding availability of the inner surface area is its steric accessibility for the adsorbate, i.e. its exclusion limit, which, for chromatography, is characterized by, for example, the mass of globular proteins which are just unable to enter the pores.

The capability for adsorption may be inherent to a solid, as in the case for activated charcoal and hydroxyapatite, or can be achieved by adsorptive modification of a base material, i.e. a preferably adsorptively inert solid of suitable morphology, involving covalent bonding of chemical units, which are referred to as ligands and which are preferably capable of selective binding, to surface anchor groups of the base material.

The advantage of membrane adsorbers over packed chromatography columns is their suitability for being run with much higher flow rates. Conversely, however, membrane adsorbers have a lower dynamic capacity than, for example, gel-permeation chromatography columns. Owing to this lower capacity of membrane adsorbers, they are not suitable for the use of highly concentrated solutions. In order to overcome this disadvantage, attempts have already been made to connect a number of these membrane adsorber units in series in order to thus combine the advantages of a high flow rate with those of a high capacity.

In this connection, the documents U.S. Pat. No. 6,294,090 B1 and DE 197 11 083 A1 describe a series connection of adsorber modules for improving the dynamic capacity of large modules run convectively. The uneven breakthrough of the target substance is to be compensated for in such an arrangement by the successive adsorber stages. For this purpose, an extremely highly depleted solution of the target substance is used and virtually complete mixing of the eluate and thus of the target substance is exploited so that a smaller adsorber stage can be used. Owing to appropriate geometry of the stages connected in series, the hydraulic permeability in all the stages is the same. Such an interconnection of chromatographic units of different sizes is, however, technically extremely complicated and, in view of the small effect, not viable.

Thus, the object of the present invention is to provide an apparatus which overcomes the above-mentioned disadvantages and leads to improved separation performance with higher productivity.

### SUMMARY OF THE INVENTION

This invention relates to an apparatus for separating or isolating substances in or from a mixture in a fluid, comprising at least one diffusion-based chromatography matrix and at least one downstream convection-based chromatography matrix, wherein the convection-based chromatography matrix is downstream of the diffusion-based chromatography matrix such that the fluid leaving the diffusion-based chromatography matrix can be conducted through the convection-based chromatography matrix.

The combination, according to the invention, of a diffusion-based chromatography matrix and a downstream convection-based chromatography matrix is referred to hereinafter as “serial (inter) connection”.

The expression “separating or isolating”, as used herein, is not subject to any specific restrictions and relates to any process which is suitable for removing a substance from a mixture. Here, the expression “separating or isolating” means, for example, that a desired target substance is isolated from a mixture present in a fluid for the purpose of purification, or that a contaminant is removed in order to free the mixture from this contaminant. This expression also includes no restrictions at all concerning the amounts to be separated and relates both to the separation of analytical substance amounts and to the preparative purification of larger substance amounts which, for example, may arise in the context of production.

Furthermore, the expression “mixture” relates to any mixture which comprises more than one substance. According to the present invention, such a mixture can comprise one component in a large excess, whereas the rest of the components of the mixture are present in small or minimal amounts. However, the term “mixture” also includes those mixtures which comprise multiple components which are present at a moderate concentration.

The expression “diffusion-based chromatography matrix”, as used herein, is not subject to any particular restrictions and includes any matrix which consists of particles and substantially exhibits a diffusion limitation of mass transfer, in that the rate of the adsorption and desorption processes is determined by the diffusion rate of the substance(s) into and out of the particles owing to the diffusion coefficients of the substance(s), which depend very heavily on the size, or the molecular weight, of the substances.

According to a further embodiment, the diffusion-based chromatography matrix is a porous, particulate adsorbent.

Examples of preferred diffusion-based chromatography matrices are porous, particulate adsorbents whose particles may be regular or irregular in shape and which can be present as filling in a column provided with an inlet and outlet. Particularly preferably, the matrices have ion-exchange groups.

Among the diffusion-based chromatography matrices having regular, for example spherical, particles, preference is given to crosslinked agaroses, such as, for example, DEAE Sepharose® CL-6B (with DEAE diethylaminoethyl ligand), Q-Sepharose® HP (with Q trimethylamine ligand), Q-Sepharose® FF, S-Sepharose® Fast Flow (with S sulfonic acid ligand).

Preferably, use can also be made of “controlled pore glass” matrices or cellulose beads, such as, for example, DEAE Sephacel®, DEAE Cellufine®, CM and C-200 Cellufine®.

Further particularly preferred diffusion-based chromatography matrices having spherical particles are dextran-based chromatography gels, such as, for example, DEAE Sephadex®, QAE Sephadex® (with QAE [(CH₃CH(OH)CH₂)(C₂H₅)₂]N⁺CH₂CH₂O ligand), SP Sephadex® (with SP propanesulfonic acid ligand).

Further particularly preferred diffusion-based chromatography matrices whose particles are spherical are polymer composite-based matrices, such as, for example, Fractogel® EMD, TMAE-650, DEAE-Toyopearl® 650S, DEAE-Trisacryl® M, DEAE-Spherodex® M, Spherosil® M, Macroprep® Q, Q Hyper® D, M Poros® 50 HQ and polyacrylamide gels present in ceramic microcapsules.

Among the diffusion-based chromatography matrices having irregular particles, preference is given to matrices selected from the group of activated charcoal, hydroxyapatite, silica and diatomaceous earth.

Particular preference is given to using a gel chromatography matrix as diffusion-based chromatography matrix, and most preferred is type Q Sepharose® FF (with Q trimethylamine ligand) from GE Healthcare Life Sciences in a HiPrep® column from GE Healthcare Life Sciences or packed in a 20 ml XK-16 column from GE Healthcare Life Sciences (hereinafter called “Q Sepharose® FF HiPrep®”). In a further preferred embodiment, use is made of type Q Sepharose® XL (Q trimethylamine ligand) from GE Healthcare Life Sciences packed in a 20 ml XK-16 column from GE Healthcare Life Sciences.

The expression “convection-based chromatography matrix”, as used herein, is not subject to any particular restrictions and includes any matrix in which application of a hydraulic pressure difference between the inflow and outflow of the matrix forces perfusion of the matrix, achieving substantially convective transport of the substance(s) into the matrix or out of the matrix, which is effected very rapidly at a high flow rate. The rate-determining step is then determined virtually only by the association constant(s) between the matrix and the substance(s).

A further embodiment of the present invention provides an apparatus as defined above, wherein the convection-based chromatography matrix is planar.

Examples of preferred convection-based chromatography matrices according to the invention are those chromatography matrices which are planar and are structures in which the dimensions in the x and y axes in the Cartesian, three-dimensional coordinate system are several times the dimension in the z axis. These flat structures can, then, in turn be convection-based chromatography matrices in the form of flat modules, stack modules, wound modules, or cylinders. Among the flat convection-based chromatography matrices, particular preference is given to filters, membranes, nonwovens, fabrics or combinations thereof.

Thus, a further embodiment of the present invention provides an apparatus as defined above, wherein the convection-based chromatography matrix is selected from the group of filters, membranes, nonwovens, fabrics and combinations thereof.

“Filters” shall be understood to mean flat structures which permit removal of substances from liquid or gaseous fluids, and, as a result of the sieve effect, the particles which are larger than the nominal retention rate of the filter are retained. These filters can bear functional groups on their surface.

In a further preferred embodiment, the convection-based chromatography matrices are monolithic, i.e. they are not made up of a multiplicity of particles, but are one-piece, cohesive and porous monoliths which are perfusable by convection. Commercially available monolithic matrices are sold by BIA, Ljubljana, Slovenia (CIM Disks) and Biorad Hercules Calif., USA (UNO Monolith).

A further embodiment of the present invention provides an apparatus as defined above, wherein the convection-based chromatography matrix is a membrane adsorber having at least one membrane.

The convection-based chromatography matrices usable most preferably according to the invention are membrane adsorbers which comprise at least one microporous membrane which optionally bears on its inner and outer surfaces functional groups which enter into physical and/or chemical interaction with the substances. “Chemical interaction” shall hereinafter be understood to mean any covalent, ionic and/or electrostatic interaction-based or hydrophobic interaction-based (e.g. van der Waals interaction) binding interaction between the functional groups and the adsorbates.

The expression “downstream” used herein relates merely to the fact that the convection-based chromatography matrix is arranged, in flow direction, after the diffusion-based chromatography matrix and should not be understood to be restrictive to any greater degree.

According to a particularly preferred embodiment of the present invention, the fluid leaving the diffusion-based chromatography matrix can be conducted completely through the convection-based chromatography matrix.

According to a specific, particularly preferred embodiment of the present invention, the convection-based chromatography matrix is directly connected to the diffusion-based chromatography matrix, so that the entire fluid which emerges from the diffusion-based chromatography matrix can be directly and completely conducted through the convection-based chromatography matrix.

According to a particularly preferred embodiment of the present invention, the combination of diffusion-based chromatography matrix and convection-based chromatography matrix is present in a compact or unitary assembly, so that simple handling, for example to service or to replace the apparatus, can be achieved without any problems.

The term “chromatography matrix” used according to the invention comprises any material at whose surface at least one component of a fluid in contact with the material can be bound. The capability for adsorption for the purposes of the present invention may be inherent to the material of the “chromatography matrix”, as in the case of activated charcoal or hydroxyapatite for example, but it can also be achieved by modifying a support material with one or more ligands, the diffusion-based chromatography matrix and/or the convection-based chromatography matrix comprising at least one ligand which interacts with at least one substance in the mixture via at least one chemical and/or physical interaction.

Examples of such usable ligands are ligands which interact with adsorbates via at least one chemical and/or physical interaction, more particularly ion exchangers, salt-tolerant ligands, chelating agents, thiophilic or hydrophobic ligands having substituents of varying chain lengths and configurations, reversed-phase ligands, reactive dyes and other dyes, inorganic molecules and ions and also organic and inorganic compounds thereof, affinity ligands, including low molecular weight uncharged or charged organic molecules, amino acids and analogs thereof, coenzymes, cofactors and analogs thereof, substrates and analogs thereof, endocrine and exocrine substances such as hormones and hormone-mimicking effectors and also analogs thereof, enzyme substrates, enzyme inhibitors and analogs thereof, fatty acids, fatty acid derivatives, conjugated fatty acids and analogs thereof, nucleic acids such as DNA and analogs and derivatives thereof, RNA and analogs and derivatives thereof, monomers and analogs and derivatives thereof, oligomers to polymers and analogs and derivatives thereof, high molecular weight carbohydrates, linear or branched, unsubstituted or substituted glycoconjugates, such as heparin, amylose, cellulose, chitin, chitosan, monomers and oligomers and also derivatives and analogs thereof, and also lignin and derivatives and analogs thereof.

Further examples are high molecular weight ligands, such as proteins and their oligomers, multimers, subunits and also parts thereof, peptides, polypeptides, analogs and derivatives thereof, lectins, antibodies and parts thereof, fusion proteins, haptens, enzymes and subunits and also parts thereof, structural proteins, receptors and effectors and also parts thereof, viruses and parts thereof, xenobiotics, pharmaceuticals and pharmaceutical active ingredients, alkaloids, antibiotics, biomimetics and catalysts.

A preferred embodiment of the present invention provides an apparatus as defined above, wherein at least the convection-based chromatography matrix comprises one or more ligands which interact(s) with adsorbates via at least one chemical and/or physical interaction and which is/are selected from the group comprising ion exchangers, salt-tolerant ligands, chelating agents, thiophilic or hydrophobic ligands of varying chain lengths and configurations, reversed-phase ligands, reactive dyes and other dyes, inorganic molecules and ions, organic and inorganic compounds thereof, affinity ligands, high molecular weight ligands, enzymes and subunits and also parts thereof, structural proteins, receptors and effectors and also parts thereof, viruses and parts thereof, xenobiotics, pharmaceuticals and pharmaceutical active ingredients, alkaloids, antibiotics, biomimetics and catalysts.

Particularly preferred ligands which are bonded to the diffusion-based and/or convection-based chromatography matrix are trimethylamine, N,N-diethyl-N-(2-hydroxy-1-propyl)ammoniomethyl, diethylaminoethyl, 2,2′-iminodiethanol, carboxymethyl, sulfopropyl and sulfomethyl ligands.

In a preferred embodiment of the apparatus according to the invention, the diffusion-based chromatography matrix and the convection-based chromatography matrix each comprise at least one ligand, wherein these ligands interact with the substances in the mixture via the same type of binding interaction (e.g. by cation or anion exchange). In a particularly preferred embodiment, both chromatography matrices bear cation-exchange ligands, such as sulfonic acid or sulfopropyl groups for example.

In a further preferred embodiment of the apparatus as defined above, both the diffusion-based chromatography matrix and the convection-based chromatography matrix comprise at least one identical ligand.

In a particularly preferred embodiment, trimethylamine is bonded as ligand to both the diffusion-based chromatography matrix and the convection-based chromatography matrix.

A further embodiment of the present invention provides an apparatus as defined above, wherein the downstream convection-based chromatography matrix has a lower static binding capacity than the upstream diffusion-based chromatography matrix.

According to a further embodiment of the present invention, the downstream convection-based chromatography matrix is a membrane adsorber unit which has less than 50%, preferably less than 20%, of the static binding capacity of the upstream diffusion-based chromatography matrix, which comprises a gel chromatography matrix.

A further aspect of the present invention provides a method for separating or isolating substances in or from a mixture, comprising the steps of (a) if necessary, dissolving the mixture in a suitable solvent or solvent mixture in order to obtain a fluid, (b) conducting the fluid through the above-defined apparatus and (c) collecting the conducted fluid.

The term “dissolving” relates to any process in which a substance is dissolved in a solvent and is not subject to any further restrictions beyond this. The “solvent” can be a pure substance or a mixture of various solvents. According to the present invention, the solvent can further comprise further compounds, such as salts, bases or acids for example. In addition, the solvent can comprise substances which are used for identifying materials or for calibration.

According to the present invention, the flow rate with which the fluid is conducted through the above-defined apparatus is in a range from 0.01 ml/min to 1000 ml/min, preferably in a range from 1 ml/min to 200 ml/min, particularly preferably in a range from 2 ml/min to 100 ml/min, and most preferably in the range from 2.5 ml/min to 50 ml/min.

According to the present invention, the respective starting concentration(s) of the target substance(s) in the fluid to be separated or to be isolated is/are in a range from 0.001 mg/ml to 1000 mg/ml, preferably in a range from 0.01 mg/ml to 50 mg/ml, particularly preferably in a range from 0.1 mg/ml to 20 mg/ml, and most preferably in a range from 1 mg/ml to 10 mg/ml, based on the individual substance.

A further embodiment provides a method as defined above, wherein the mixture is a solution from a synthesis, a biomolecule-containing fluid or a bioparticle-containing fluid.

“Biomolecule-containing fluid” shall be understood here to mean a fluid which comprises substances selected from the group of the amino acids and analogs thereof, coenzymes, cofactors and analogs thereof, the endocrine and the exocrine substances, such as hormones and hormone-mimicking effectors, and analogs thereof, enzymes and subunits and also parts thereof, enzyme substrates, enzyme inhibitors and analogs thereof, fatty acids, fatty acid derivatives, conjugated fatty acids and analogs thereof, the deoxyribonucleic acids and ribonucleic acids and analogs and derivatives thereof, single- to multi-stranded plasmids, cosmids and other constructs, carbohydrates and glycoconjugates, proteins and their oligomers, multimers, subunits and also parts thereof, peptides, polypeptides, analogs and derivatives thereof, lectins, antibodies and parts thereof, fusion proteins, haptens, structural proteins, receptors and effectors and also parts thereof, xenobiotics, pharmaceuticals, alkaloids, antibiotics, biomimetics, allergens and combinations thereof.

“Bioparticle-containing fluid” shall be understood here to mean a fluid which comprises particles selected from the group of the viruses and parts thereof, prions and parts thereof, microorganisms, prokaryotes, protozoa, yeasts, fungi, eukaryotes of animal and plant origin, cell wall components of prokaryotes, protozoa, yeasts, fungi, eukaryotes of animal and plant origin and parts thereof, biological membranes and parts thereof, subcellular biological membranes and parts thereof, and combinations thereof.

A preferred embodiment of the present invention provides the above-defined method, wherein the mixture is blood plasma and the substance to be isolated is serum albumin.

A further aspect of the present invention provides for the use of the above-defined apparatus for separating or isolating at least one target substance in or from a mixture.

Such a use is not restricted to a particular technical field and comprises all applications in which substances have to be separated or isolated from a mixture. Examples of such fields are chemical, pharmaceutical, medical or biological research or production.

### BRIEF DESCRIPTION OF THE DRAWINGS

FIG. 1 shows breakthrough curves of the nonbinding substance acetone at a flow rate of 10 ml/min for determining the dead volume of the following various configurations:

Graph 1 shows the breakthrough curve of the “AKTA Prime plus” chromatography system from the manufacturer General Electrics (GE) Healthcare (called hereinafter “AKTA”) without column and adsorber.

Graph 2 shows the breakthrough curve of the AKTA chromatography system combined with the membrane adsorber module Sartobind® Q Nano (30-ply, 8 mm bed height, 3 ml membrane volume) from the manufacturer Sartorius Stedim Biotech GmbH (hereinafter called “Sartobind® Q Nano” or “Nano”).

Graph 3 shows the breakthrough curve of the combination of AKTA, a Q Sepharose® FF HiPrep® column (hereinafter called “Q Sepharose® FF HiPrep®” or “HiPrep®”).

Graph 4 shows the breakthrough curve of the combination of AKTA, Q Sepharose® FF HiPrep® and Sartobind® Q Nano (serial (inter)connection).

FIG. 2 shows a comparison of the breakthrough curves for a Q Sepharose® FF HiPrep® column (“HiPrep”) and a serial interconnection (“Chrom2”, i.e. a combination of the Q Sepharose® FF HiPrep® column and Sartobind® Q Nano) at a flow rate of 5 ml/min. The concentration of the protein (bovine serum albumin) was 2 g/l in both cases.

FIG. 3 shows a comparison of the breakthrough curves for a Q Sepharose® FF HiPrep® column (“HiPrep”) and a serial interconnection (“Chrom2”, i.e. a combination of the Q Sepharose® FF HiPrep® column and Sartobind® Q Nano) at a flow rate of 7.5 ml/min. The concentration of the protein (bovine serum albumin) was 2 g/l in both cases.

FIG. 4 shows a comparison of the breakthrough curves for a Q Sepharose® FF HiPrep® column (“HiPrep”) and a serial interconnection (“Chrom2”, i.e. a combination of the Q Sepharose® FF HiPrep® column and Sartobind® Q Nano) at a flow rate of 10 ml/min. The concentration of the protein (bovine serum albumin) was 2 g/l in both cases.

FIG. 5 is a highly schematic illustration of a chromatography apparatus in accordance with the invention.

### DETAILED DESCRIPTION OF THE PREFERRED EMBODIMENTS

The chromatography apparatus according to the invention is identified generally by the numeral 10 in FIG. 5 and includes a diffusion-based chromatography matrix 20 and a downstream convection-based chromatography matrix 30, and enables the separation or isolation of a target substance in or from a mixture in a surprisingly effective manner. The combination of a gel chromatography column as the diffusion-based chromatograph matrix with the convection-based chromatography matrix 30, i.e. a membrane adsorber unit, results, especially advantageously, in improved productivity without loss of the dynamic binding capacity and is characterized by a surprisingly steep breakthrough curve of the target substance. Thus, the advantages of column chromatography can, surprisingly, be combined with those of (membrane) adsorption chromatography. The apparatus 10 according to the invention and use thereof enable the effective separation of substances which, for example, are produced by culturing microorganisms or which are isolated from biological fluids, such as blood. These effects according to the invention are surprising, because a gel chromatography matrix 20 and a membrane adsorber matrix 30 are fundamentally subject to different operating parameters (static and dynamic capacity, flow rates, etc.), and so a direct combination of the two in one assembly is particularly far-fetched. Through the combination of a gel chromatography matrix 20 and a downstream membrane adsorber unit 30 in the apparatus 10 according to the invention, the productivity for the target substances to be removed or purified without loss of the dynamic binding capacity is at least 30% higher than the productivity of the gel chromatography matrix 20.

### EXAMPLES

The present invention is explained in more detail below by means of the examples, but without being restricted thereby in any manner.

### Example 1

### Improving the Dynamic Binding Capacity by Using a Chromatography Column and Membrane Adsorber

A Q Sepharose® FF HiPrep® column was provided by packing a ml XK 16 column from General Electrics (GE) Healthcare Life Sciences with 20 ml of a type Q Sepharose® FF (strong anion exchanger), ordering number 17-507201, lot number 302853. The ligand is trimethylamine, where R denotes the matrix (R—N⁺—(CH₃)₃).

As a second stage, a membrane stack of Sartobind® Q Nano, 30-ply, 8 mm bed height, having a membrane volume of 3 ml from Sartorius Stedim Biotech GmbH was used. The ligand is trimethylamine, where R denotes the matrix (R—N⁺—(CH₃)₃).

The components were inserted, both individually and in the combination of Q Sepharose® FF HiPrep® column and Sartobind® Q Nano, into an “AKTA Prime plus” chromatography system from GE Healthcare (hereinafter “AKTA”). The fluid emerging from the adsorbers was measured at 280 nm in an integrated flow-through photometer. The data were transferred to a connected computer and depicted graphically.

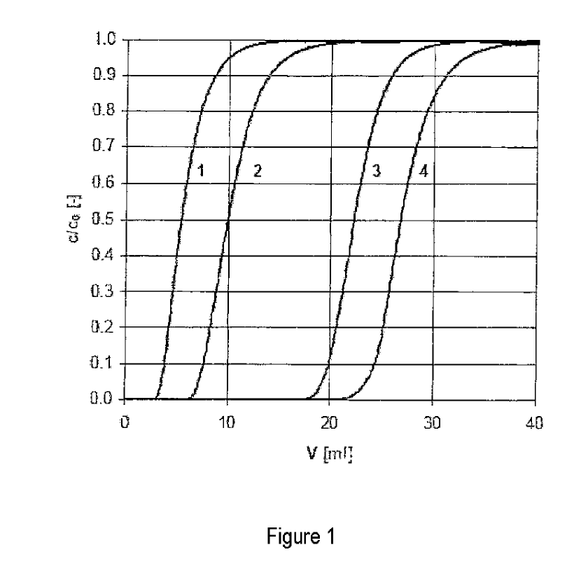

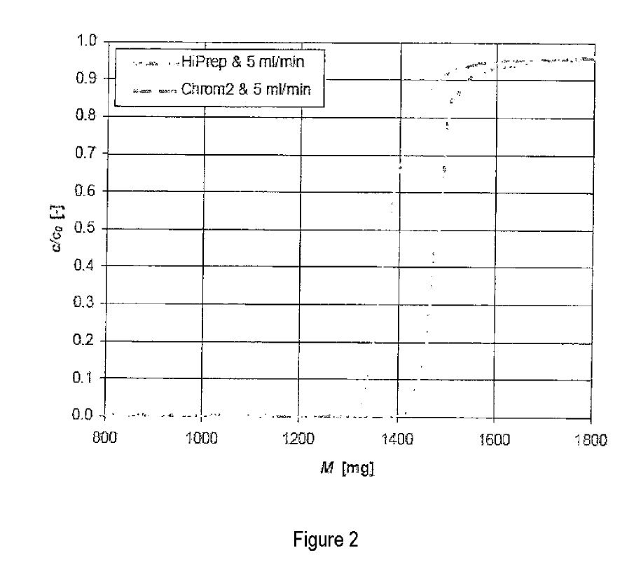

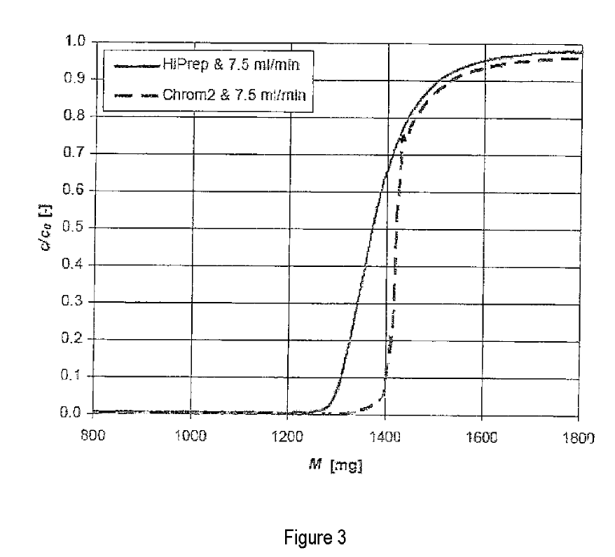

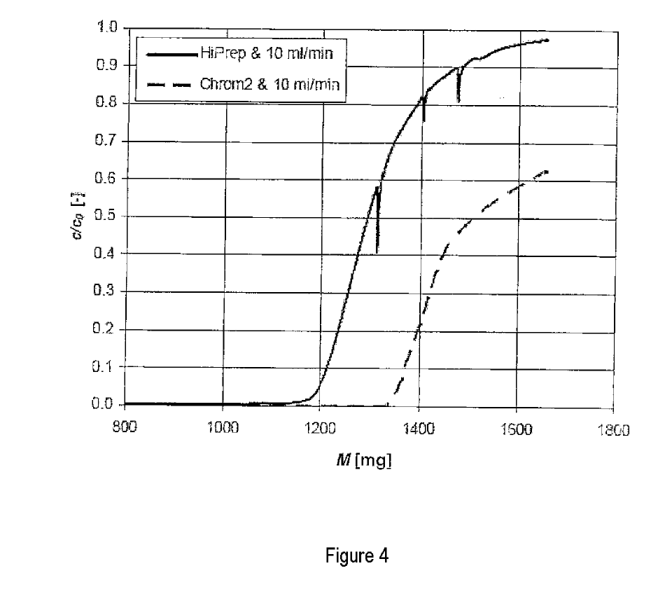

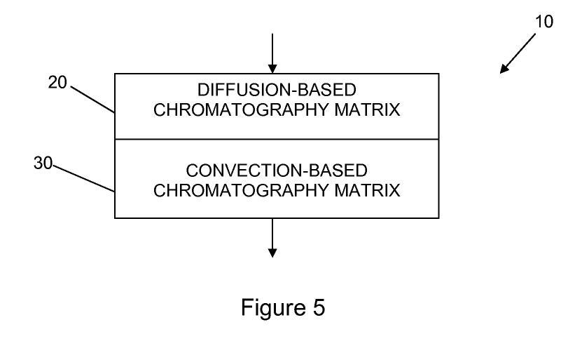

Firstly, the system dispersion was recorded based on breakthrough curves with the nonbinding substance acetone for the various combinations. FIG. 1 shows the respective breakthrough curves.

The dead volume values ascertained here are shown below in table 1:

TABLE 1
List of the dead volumes

| Configuration | Dead volume (ml) |
|---|---|
| ÄKTA | 5.90 |
| ÄKTA + Nano | 10.48 |
| ÄKTA + HiPrep | 22.55 |
| ÄKTA + HiPrep + Nano | 26.44 |

Then, breakthrough curves with bovine serum albumin (BSA) were recorded. For this purpose, BSA from SIGMA-Aldrich, ordering number A2153, was dissolved at a concentration of 2 g/l in a 0.01 mol/l potassium phosphate buffer of pH 7.0, which had been prepared by mixing KH₂PO₄ solution with K₂HPO₄ solution, and sterile-filtered using the membrane filter units, Sartolab RF vacuum filtration units, ordering number 18082-E, from Sartorius Stedim Biotech GmbH Gottingen, Germany, having a nominal pore size of 0.2 μm. Using this solution, dynamic binding capacities (DBC) at various rates were recorded. The results are shown in FIGS. 2, 3 and 4.

### Example 2

### Measuring Breakthrough Curves

Using the components, i.e. column and membrane adsorber, described in example 1, complete breakthrough curves (including washing and elution with 1 M NaCl) were ascertained.

TABLE 2
Abbreviations used

C = concentration
DBC = dynamic binding capacity
A = amount (mg)
MA = membrane adsorber
tot = total
ser. = serial
V = volume (ml)

The following symbols, definitions and formulae are used:

A_{bt,10%}=loading with BSA until 10% breakthrough

From A_{bt,10%}, the amount of protein in the dead volume is subtracted:

A_{ads,10%}=A_{bt,10%}−C_{starting solution}×Vₜₒₜ

The amount of the eluted protein was ascertained by adding up the amounts measured in the elution fractions.

The increase in the amount of protein bound owing to the serial connection of column and membrane adsorber for each flow rate is defined as follows:

Dynamic binding capacity at 10% breakthrough:

$${DBC}_{10 \%} = \frac{{A}_{ads , 10 \%}}{{V}_{adsorbent}} ,$$

wherein adsorbent refers to the respective adsorber used.

Dynamic binding capacity of the Q Sepharose® FF HiPrep® column at 10% breakthrough for the serial connection:

$${DBC}_{10 \%} = \frac{{A}_{ads , 10 \% ser . connection} - {A}_{ads , 10 \% MA}}{{V}_{column}}$$

$$Δ {A}_{ads , 10 \%} = {A}_{ads , ser . connection , 10 \%} - {A}_{ads , column , 10 \%}$$

$$Δ {A}_{ads , rel , 10 \%} = \frac{{A}_{ads , ser . connection 10 \%} - {A}_{ads , column , 10 \%}}{{A}_{ads , column , 10 \%}} \times 100 \%$$

The efficiency E of the membrane adsorber (the ratio of ΔA_{ads,10%} to the capacity of the membrane adsorber) is determined as follows:

$$E = \frac{Δ {A}_{ads , 10 \%}}{{A}_{ads , MA , 10 \%}} \times 100 \%$$

TABLE 3
Summary of the results obtained with membrane adsorber
and column alone and in the serial interconnection

| | MA | Column | | | | |
|---|---|---|---|---|---|---|
| | alone | alone | Serial connection | | | |
| Flow | A_{ads, 10%} | A_{ads, 10%} | A_{ads, 10%} | ΔA_{ads, 10%} | | |
| rate | (mg | (mg | (mg | (mg | ΔA_{ads, rel, 10%} | Efficiency |
| (ml/min) | total) | total) | total) | total) | (%) | (%) |
| 5 | 51.0 | 1297 | 1401 | 104 | 8.0 | 203 |
| 10 | 55.8 | 1167 | 1326 | 159 | 13.6 | 284 |

TABLE 4
Productivity of the column alone and of the serial interconnection

| | | | Productivity | |
|---|---|---|---|---|
| | Protein | Loading | (mg/ml × min) | |
| Flow rate | concentration | time | | Serial |
| (ml/min) | (mg/ml) | (min) | Column alone | connection |
| 5 | 1.9 | 137 | 0.48 | — |
| 10 | 2.2 | 60 | — | 0.97 |

In all 3 cases tested (FIGS. 2 to 4), the combination exhibits an increase in the dynamic binding capacity, i.e. in the amount of protein bound at 10% breakthrough, and in addition a steeper rise of the breakthrough curve, since the protein emerging from the column is bound to the membrane adsorber. The steepness of the breakthrough curve of the apparatus according to the invention with a serial connection is then determined by the breakthrough curve of the membrane adsorber. This behavior is even more pronounced at higher flow rates and with larger membrane adsorber units.

It is clear from table 3 that the efficiency of the membrane adsorber rises extremely sharply (203 to 284%) owing to the serial interconnection with the column.

It is clear from table 4 that the productivity of the serial connection compared to the column alone was doubled without loss of the dynamic binding capacity, although only a low volume (13% of the total adsorber volume) of membrane adsorber was added.

1. An apparatus for separating or isolating substances in or from a mixture in a fluid, comprising at least one diffusion-based chromatography matrix and at least one downstream convection-based chromatography matrix, wherein the convection-based chromatography matrix is downstream of the diffusion-based chromatography matrix such that the fluid leaving the diffusion-based chromatography matrix can be conducted through the convection-based chromatography matrix.

2. The apparatus of claim 1, wherein the fluid leaving the diffusion-based chromatography matrix can be conducted completely through the convection-based chromatography matrix.

3. The apparatus of claim 1, wherein the diffusion-based chromatography matrix is a porous, particulate adsorbent.

4. The apparatus of claim 1, wherein the convection-based chromatography matrix is planar.

5. The apparatus of claim 4, wherein the convection-based chromatography matrix is selected from the group of filters, membranes, nonwovens, fabrics and combinations thereof.

6. The apparatus of claim 4, wherein the convection-based chromatography matrix is a membrane adsorber having at least one membrane.

7. The apparatus of claim 1, wherein the convection-based chromatography matrix is monolithic.

8. The apparatus of claim 1, wherein the diffusion-based chromatography matrix and/or the convection-based chromatography matrix comprises at least one ligand which interacts with at least one substance in the mixture via at least one chemical and/or physical interaction.

9. The apparatus of claim 8, wherein the diffusion-based chromatography matrix and the convection-based chromatography matrix comprise at least one identical ligand.

10. The apparatus of claim 9, wherein the ligand is selected from the group of the ion exchangers, salt-tolerant ligands, chelating agents, thiophilic or hydrophobic ligands of varying chain lengths and configurations, reversed-phase ligands, reactive dyes and other dyes, the inorganic molecules and ions, organic and inorganic compounds thereof, affinity ligands, high molecular weight ligands, enzymes and subunits and also parts thereof, structural proteins, receptors and effectors and also parts thereof, viruses and parts thereof, xenobiotics, pharmaceuticals and pharmaceutical active ingredients, alkaloids, antibiotics, biomimetics and the catalysts.

11. A method of separating or isolating substances in or from a mixture, comprising the steps of:
(a) if necessary, dissolving the mixture in a suitable solvent or solvent mixture in order to obtain a fluid,
(b) conducting the fluid through the apparatus of claim 1, and
(c) collecting the conducted fluid.

12. The method according to claim 11, wherein the mixture is a solution from a synthesis, a biomolecule-containing fluid or a bioparticle-containing fluid.

13. (canceled)
